(19) United States
(12) Patent Application Publication
(10) Pub. No.: US 2005/0061238 A1
(43) Pub. Date: Mar. 24, 2005

(54) Thin film fabrication apparatus

(75) Inventor: Kazuaki Sakurada, Suwa-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 10/795,441

(22) Filed: Mar. 9, 2004

(30) Foreign Application Priority Data
Mar. 11, 2003 (JP) JP 2003-065318
Feb. 17, 2004 (JP) JP 2004-040066

(51) Int. Cl. B05C 5/00

(52) U.S. Cl. 118/300

(57) ABSTRACT

There is provided a thin film fabrication apparatus that has a substrate stage, a droplet discharge head, a tank, and a tube. The substrate stage holds a substrate. The droplet discharge head is disposed above the substrate stage and discharges liquid crystal on the substrate. The tank contains the liquid crystal. The tube connects the tank and the discharge head to supply the liquid crystal from the tank to the discharge head. The tube and the tank are configured from antistatic material. The droplet discharge head is a piezojet type, and at least a part of the area in contact with the liquid crystal is configured from antistatic material.

### BACKGROUND OF THE INVENTION

1. Field of the Invention

The present invention relates to a thin film fabrication apparatus, and particularly relates to a thin film fabrication apparatus having a droplet discharge head.

2. Background Information

A liquid crystal device generally is formed by attaching a backlight or another such illuminating device, or a liquid crystal drive IC or other such additional equipment to a liquid crystal display panel structured with a liquid crystal sealed between a pair of substrates.

Also, a liquid crystal display panel is generally formed by affixing a first substrate 1 on which a first electrode is formed and a second substrate 4 on which a second electrode is formed to each other by a seal portion 2, and sealing a liquid crystal 3 in the gap, which is called a cell gap, formed between the substrates 1 and 4, as shown in FIG. 20. The symbol 5 denotes a sealing section for sealing the inlet after liquid crystal injection.

The liquid crystal is generally sealed in the cell gap by so-called injection methods.

Liquid crystal injection is a method of injecting liquid crystal from a liquid crystal inlet by means of a pressure difference in a vacuum, and the method for filling the liquid crystal is as follows.

First, the liquid crystal display element (hereinafter referred to as the liquid crystal display cell) prior to sealing is sufficiently deaerated in a vacuum, then the inlet is sealed with liquid crystal. This liquid crystal display cell is then returned to atmospheric conditions and is filled by utilizing the surface tension and the pressure difference inside and outside the liquid crystal display cell.

Therefore, much time is required for the liquid crystal display element to grow larger. A large substrate with a diagonal of 1 m or greater requires one day or more to grow, which is unrealistic in terms of manufacturing.

In view of this, it has been proposed in conventional practice that instead of injecting liquid crystal, a droplet discharge head based on ink jetting, for example, be used to discharge liquid crystal 3 in the frame of a first substrate 1 made by forming a frame-shaped seal portion 2, and then an opposing second substrate 4 should be affixed, as shown in FIGS. 21-1 to 21-4 (see JP (Kokai) No. H05-281562, JP (Kokai) No. H10-221666, and JP (Kokai) No. 2001-183674).

However, in the conventional inkjet methods described in Patent Literature 1 through 3, the display quality of the liquid crystal panel is reduced when, for example, dirt, dust, and other such foreign matter contaminates the liquid crystal due to charging when the liquid crystal flows through the flow channel. Also, a state of stable discharge cannot be achieved due to the disruption of molecular orientation, disruption of the meniscus of the droplet discharge head, and the like.

In addition, the liquid crystal panel develops display defects due to ion conduction when ions or the like enter the liquid crystal.

It will be clear to those skilled in the art from the disclosure of the present invention that an improved thin film fabrication apparatus is necessary because of the above-mentioned considerations. The present invention meets the requirements of these conventional technologies as well as other requirements, which will be apparent to those skilled in the art from the disclosure hereinbelow.

### SUMMARY OF THE INVENTION

An object of the present invention is to provide a thin film fabrication apparatus whereby a coating solution can be applied to a substrate in a stable manner.

The thin film fabrication apparatus of the present invention includes a substrate stage, a droplet discharge head, and the like. The substrate stage holds the substrate. The droplet discharge head is disposed above the substrate stage and discharges a coating solution on the substrate. At least a part of the section of the droplet discharge head in contact with the coating solution is configured from antistatic material.

Another thin film fabrication apparatus relating to the present invention includes a substrate stage, a droplet discharge head, a tank, and a tube. The substrate stage holds the substrate. The droplet discharge head is disposed above the substrate stage and discharges a coating solution onto the substrate. The tank contains the coating solution. The tube connects the tank and the discharge head to supply the coating solution from the tank to the discharge head. The tube is configured from antistatic material.

Thus, charging in the coating solution is prevented, and contamination in the coating solution from dirt, dust, and other such foreign matter, for example, is reduced. Disruption of the molecular orientation is also reduced. Thus, the discharge of droplets from the droplet discharge head is stabilized, and the application of the coating solution onto the substrate is stabilized.

Possible examples of the above-mentioned coating solution include liquid crystals, organic EL ink materials, and other such film materials. The coating solution is prepared by dissolving or dispersing a film material in a solvent.

According to this configuration, it is possible to manufacture a highly reliable electrooptic apparatus. Examples of such an electrooptic apparatus (flat-panel display) include color filters, liquid crystal display devices, organic EL (electroluminescence: hereinafter abbreviated as “EL”) devices, PDP apparatuses, electron emission apparatuses, and the like. The concept of an electron emission apparatus includes a so-called FED (field emission display) or SED (surface-conduction electron-emitter display) apparatus. Further examples of an electrooptic apparatus include devices involving metal wiring formation, lens formation, resist formation, light diffuser formation, and the like.

The objectives, characteristics, merits, and other attributes of the present invention described above shall be clear to those skilled in the art from the description of the invention hereinbelow. The description of the invention and the accompanying diagrams disclose the preferred embodiments of the present invention.

### BRIEF DESCRIPTION OF THE DRAWINGS

Referring to the accompanying diagrams, which partially disclose the present invention:

FIG. 1 is a schematic view of the thin film fabrication apparatus relating to the first embodiment;

FIG. 2 is a schematic view of the droplet discharge head relating to the first embodiment;

FIG. 3 is a schematic view of the droplet discharge head relating to the first embodiment;

FIG. 4 is a structural diagram of a liquid-crystal panel;

FIG. 5 is a partial cross-sectional view of a display device, which is an organic EL device;

FIG. 6 is a flow chart describing the process of manufacturing a display device, which is an organic EL device:

FIG. 7 is a process drawing describing the formation of an inorganic bank layer;

FIG. 8 is a process drawing describing the formation of an organic bank layer;

FIG. 9 is a process drawing describing the process of forming a hole injection/transportation layer;

FIG. 10 is a process drawing describing a state in which a hole injection/transportation layer has been formed;

FIG. 11 is a process drawing describing the process of forming a blue luminous layer;

FIG. 12 is a process drawing describing a state in which a blue luminous layer has been formed;

FIG. 13 is a process drawing describing a state in which a multicolored luminous layer has been formed;

FIG. 14 is a process drawing describing the formation of a cathode;

FIG. 15 is a partial exploded perspective view of a display device, which is a plasma display device (PDP device);

FIG. 16 is a partial cross-sectional view of a display device, which is an electron emission device (FED device);

FIG. 17-1 is a plan view of the area around the electron emitting section of a display device;

FIG. 17-2 is a plan view showing the formation method thereof;

FIG. 18 is a perspective view of a personal computer;

FIG. 19 is a perspective view of a portable phone;

FIG. 20 is a schematic view of a liquid crystal panel;

FIG. 21-1 is a schematic process drawing of a liquid crystal inkjet method;

FIG. 21-2 is a schematic process drawing of a liquid crystal inkjet method;

FIG. 21-3 is a schematic process drawing of a liquid crystal inkjet method; and

FIG. 21-4 is a schematic process drawing of a liquid crystal inkjet method

### DESCRIPTION OF THE PREFERRED EMBODIMENTS

Embodiments of the present invention will now be described with reference to the drawings. As will be apparent from the disclosure of the present invention to those skilled in the art, the description of the invention embodiments is intended solely to illustrate the present invention and should not be construed as limiting the scope of the present invention, which is defined by the claims described below or by equivalent claims thereof.

The preferred embodiments of the present invention will now be described with reference to the drawings.

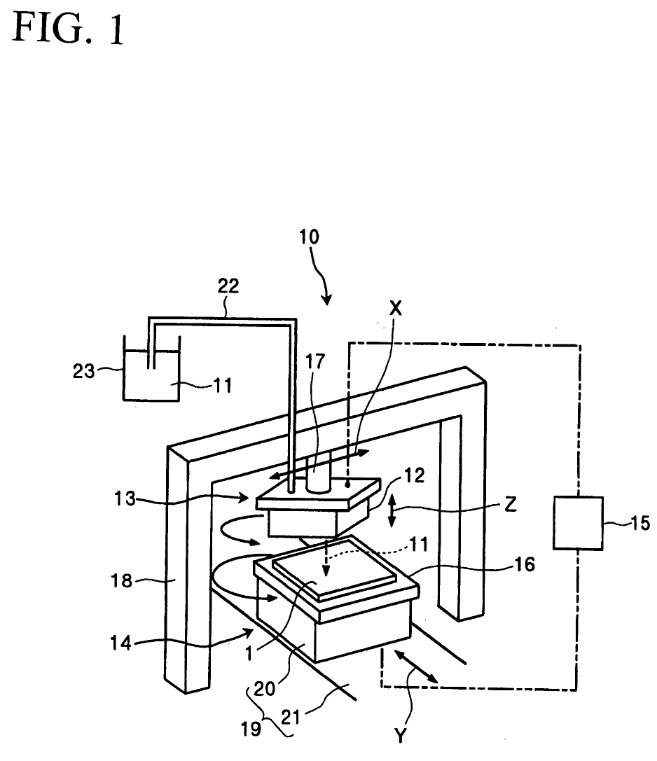

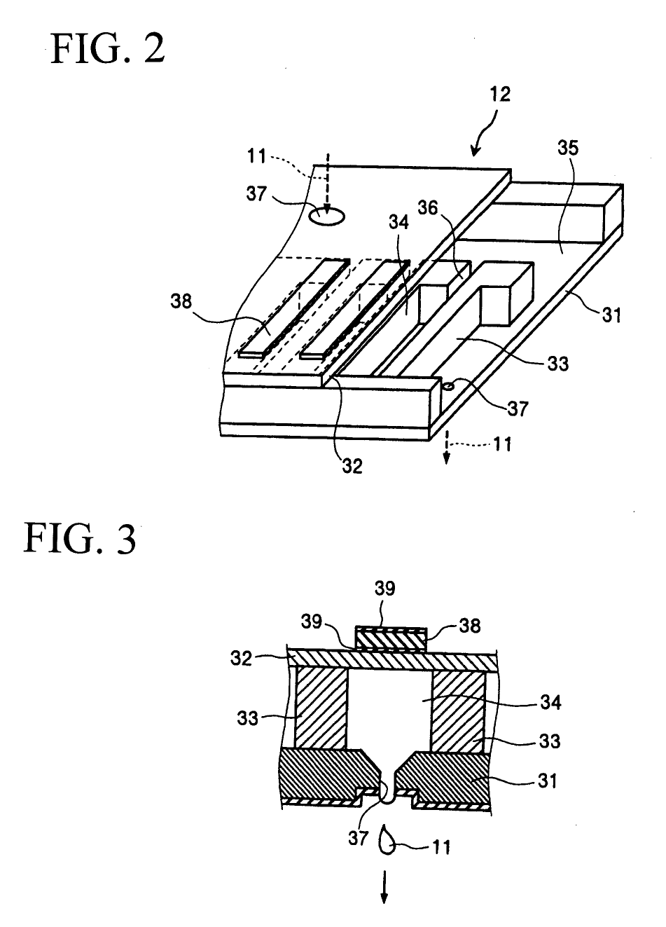

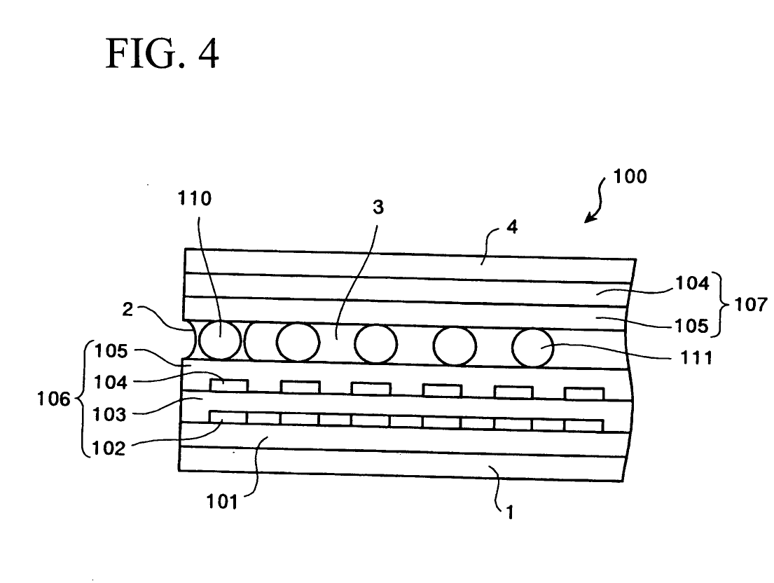

FIG. 1 is a schematic view of the thin film fabrication apparatus relating to the present embodiment. FIG. 2 and FIG. 3 are schematic views of a droplet discharge head. FIG. 4 is a structural diagram of a liquid-crystal panel.

First, the configuration of a liquid crystal display panel, which is an electrooptic device relating to the present invention, will be described with reference to FIG. 4. A liquid crystal display panel 100 relating to the present embodiment has a first substrate 1 and a second substrate 4 disposed to face each other, and liquid crystal display elements 106 and 107 are respectively formed on the inner surfaces of the first substrate 1 and second substrate 4.

Specifically, a reflective film (aluminum, silver, or the like) 101, a color filter (CF) 102, an overcoat (OVC) layer 103, a transparent electrode 104, and an oriented film 105 are sequentially formed on the first substrate 1 to produce the liquid crystal display element 106 next to the first substrate, as shown in FIG. 4.

A transparent electrode 104 and an oriented film 105 are formed on the opposite second substrate 4.

The transparent electrode 104 is formed from ITO (indium tin oxide) or another transparent electrode material and a specific pattern is machined thereon to form the liquid crystal display element 106 next to the second substrate. The oriented film 105 has a film of polyimide (PI), for example, or the like formed thereon, and is subjected to orientation treatment (rubbing treatment).

A seal portion 2 with dispersed gap retention particles 110 is formed in a roughly rectangular shape in the inner periphery between the first substrate 1 and second substrate 4 on which the liquid crystal display elements are thus formed, and the substrates are sealed while separated by a specific gap, a so-called cell gap, by gap retention particles 111, which serve as a spacer. A liquid crystal area is then created between the first substrate 1 and the second substrate 4 by the seal portion 2.

A thin film fabrication apparatus for manufacturing the liquid crystal display device relating to the present embodiment will now be described.

The thin film fabrication apparatus 10 of the present embodiment is used to form thin films (liquid crystals) that are to be formed on substrates in liquid crystal display devices as shown in FIG. 1, and is designed in the present embodiment to discharge a liquid crystal 3 into the seal portion 2 formed in a frame shape on the surface of the first substrate 1 on which the liquid crystal display element 106 is formed. The second substrate 4 on which the opposite liquid crystal display element 107 is formed is then affixed to form a liquid crystal display device such as is shown in FIG. 4.

A commercial adhesive can be used as the sealant for forming the seal portion, but it is preferable to use an adhesive that breaks up the gap retention particles to maintain the thickness between the substrates and to control the amount of the liquid crystal.

It is also possible to adopt an arrangement in which the substrate gap is kept uniform by forming the seal portion and then distributing the gap retention particles across the substrates.

Also, the step for distributing the gap retention particles may be omitted by using a droplet discharge device to discharge a liquid crystal in which the gap retention particles have been dispersed.

A thermosetting adhesive or a photocuring adhesive can be used as the sealant, and the gap retention particles may be silica particles, polystyrene particles, or other such plastic particles; particles obtained by coating silica particles with a thermoplastic resin; or the like. The area enclosed by the frame-shaped seal portion formed on the substrates is then coated in a planar fashion with the necessary amount of liquid crystal from a droplet discharge nozzle.

After the resulting substrate and another substrate are laminated together, a liquid crystal display element can be obtained by curing the adhesive. The substrates are preferably laminated in a vacuum.

The thin film fabrication apparatus 10 relating to the present embodiment is provided with droplet discharge means 13 having a droplet discharge head 12 for discharging, for example, liquid crystal or another such coating solution 11 onto the surface of the first substrate 1 on which the liquid crystal display element is formed, movement means 14 for moving the positions of the droplet discharge head 12 and the substrate 1 relative to each other, and control means 15 for controlling the droplet discharge means 13 and the movement means 14, as shown in FIG. 1.

The movement means 14 is configured from a head support section 17 that supports the droplet discharge head 12 facing downward above the substrate 1 mounted on a substrate stage 16, and that can be moved in the X-axis direction by a movable stage 18, and a stage drive section 19 for causing the substrate to move in the Y-axis direction along with the substrate stage 16 in relation to the droplet discharge head 12 above, as shown in FIG. 1.

The head support section 17 includes, for example, a linear motor or other such mechanism capable of moving and positioning the droplet discharge head 12 at a desired rate of movement in the vertical direction (Z-axis) in relation to the substrate 1, and a stepping motor or another such mechanism capable of setting the desired angle in relation to the underlying substrate 1 by rotating the droplet discharge head 12 around a vertical axis.

The stage drive section 19 includes a O-axis stage 20 capable of setting the desired angle in relation to the overlying droplet discharge head 12 by rotating the substrate stage 16 around a vertical axis, and a stage 21 for moving and positioning the substrate stage 16 in the horizontal direction (Y direction) in relation to the droplet discharge head 12. The O-axis stage 20 is configured from a stepping motor or the like, and the stage 21 is configured from a linear motor or the like.

The droplet discharge means 13 includes a droplet discharge head 12 and a tank 23 connected thereto via a tube 22. The tank 23 contains the coating solution 11, and the coating solution 11 is supplied to the droplet discharge head 12 via the tube 22. Such a configuration allows the droplet discharge means 13 to discharge the coating solution 11 contained in the tank 23 from the droplet discharge head 12 and to apply the solution to the substrate 1. The droplet discharge head 12 compresses a liquid chamber by means of a piezoelement, for example, discharges droplets (liquid material) due to the pressure, and has a plurality of nozzles (nozzles) aligned in one line or a plurality of lines.

One example of the configuration of the droplet discharge head 12 will now be described with reference to FIGS. 2 and 3. The droplet discharge head 12 includes, for example, a stainless nozzle plate 31 and an oscillating plate 32, which are joined via a separating member (reservoir plate) 33, as shown in FIGS. 2 and 3. A plurality of spaces 34 and a liquid collector 35 are formed between the nozzle plate 33 and the oscillating plate 32 by the separating member. The spaces 34 and the liquid collector 35 are filled with liquid material (not shown), and the spaces 34 and liquid collector 35 are communicated via a supply opening 36. A small nozzle 37 to spray liquid material 11 from the spaces 34 is formed in the nozzle plate 31. A hole 37 to supply the coating solution 11 to the liquid collector 35 is formed in the oscillating plate 32.

A piezoelectric element (piezoelement) 38 is joined on the surface of the oscillating plate 32 opposite the surface facing the spaces, as shown in FIGS. 2 and 3. This piezoelectric element 38 is positioned between a pair of electrodes 39, 39 as shown in FIG. 3, and is designed to flex to protrude to the exterior when supplied with an electric current. The oscillating plate 32 to which the piezoelectric element 38 is joined in such a configuration is designed to flex simultaneously toward the exterior integrally with the piezoelectric element 38, whereby the internal capacity of the spaces 34 increases. Therefore, an amount of liquid material equivalent to the increase in capacity flows into the spaces 34 from the liquid collector 35 via the supply opening 36. When the current supplied from this state to the piezoelectric element 38 is cut off, the piezoelectric element 38 and the oscillating plate 13 both return to their original shape. Therefore, since the spaces 34 also return to their original capacity, the pressure of the coating solution 11 in the spaces increases, and the sprayed droplets of the liquid material are discharged from the nozzle 37 onto the substrate 1.

The system of the droplet discharge head 12 may be a system other than the piezojet type that uses a piezoelectric element as described above, and may be designed to expel liquid crystal, which is the coating solution 1, from the above-mentioned small hole by causing oscillation with the aid of an ultrasonic motor, linear motor, or the like, or by creating pressure in the tank. The liquid crystal in the tank is preferably subjected to degassing treatment in advance. The droplet discharge head 13 may be configured as a so-called bubble jet® system, wherein either the liquid crystal in the tank or a mixture of the liquid crystal and a volatile liquid of low viscosity is heated, and the liquid crystal is expelled from the small hole due to the expansion and foaming of the resulting substance.

The control means 15 is configured from a microprocessor or another such CPU for controlling the entire apparatus, or from a computer or other device having input/output functions for various signals, and is designed to control at least one of the discharge operation of the droplet discharge means 13 and the movement operation of the movement means 14, or to control both in the present embodiment, by being electrically connected to both the droplet discharge means 13 and the movement means 14, as shown in FIG. 1.

Such a configuration allows the discharge conditions of the liquid discharge solution to be adjusted and the amount of thin film (liquid crystal) coating thus formed to be controlled.

Specifically, the control means 15 includes the following as functions for controlling the amount of coating: a control function for adjusting the discharge interval for the liquid discharge solution for the substrate, a control function for adjusting the amount of liquid discharge solution discharged per dot, control means for adjusting the angle (θ) between the direction of nozzle alignment and the direction of movement from the movement mechanism, and a control function for dividing the substrate into a plurality of areas and setting the discharge conditions in each area.

Furthermore, the control means 15 includes the following as control functions for adjusting the discharge interval: a control function for adjusting the rate of relative movement between the substrate 1 and the droplet discharge head 12 to adjust the discharge interval, a control function for adjusting the time interval between discharges in the movement means to adjust the discharge interval, and a function for arbitrarily setting the nozzles that simultaneously discharge the coating solution from among the plurality of nozzles to adjust the discharge interval.

In the present invention, the material of the members that come in contact with the coating solution 11 (for example, the tube, tank, and discharge nozzle 12) is a nonionic antistatic material.

The nonionic antistatic material should at least be used particularly for the tube 22, on which the coating solution 11 has the largest range of contact.

The tube 22 may be formed from a material that includes the nonionic antistatic material, or may be coated on the interior with the nonionic antistatic material.

For example, polypropylene, polyethylene, polystyrene, or another such tube or resin material is made of the nonionic material, and antistatic effects can be realized by kneading or coating the nonionic material with a nonionic surfactant.

The term “nonionic antistatic material” used herein refers to the nonionic materials found among antistatic materials.

Possible examples of such antistatic materials include various surfactants, inorganic salts, polyvalent alcohols, metal compounds, materials made of carbon or the like kneaded into resin materials, and coated materials. Particularly, a nonionic surfactant, a cationic surfactant, an anionic surfactant, or the like can be used for the surfactant.

Also, heating means for heating the tank, tube, and droplet discharge head as necessary may be provided to increase the temperature of the liquid crystal, which is the coating solution 11, and to maintain liquidity. The viscosity of the coating solution 11 should preferably be 20 mPa·s or less when inkjet methods are used, and is about 12 mPa·s due to heating to about 60 degrees when liquid crystal is used. The nozzle diameter is about 27 to 28 μm, for example.

Thus, in the present invention, antistatic material or nonionic material or a combination of the two is used for at least a part of the direct-contact member while the liquid crystal, which is the coating solution 11, is moved from the tank to the droplet discharge head.

In the present embodiment, the tank 23 for containing the coating solution 11, the tube 22 for supplying the coating solution 11 to the droplet discharge head 13, and the droplet discharge head 13 are configured using a nonionic electroconductive material.

As a result, the use of nonionic material has made it possible to prevent ions from being mixed in the liquid crystal and to prevent degradation of display quality in the liquid crystal display due to ion conduction.

Also, due to the use of antistatic material, the contamination of the liquid crystal with dust or dirt and the disruption of the discharge nozzle meniscus due to the disruption of the molecular orientation can be prevented, the coating solution can be discharged from the droplet discharge head in a stable fashion, and it is possible to improve the manufacturing yield rate.

The coating solution 11 is supplied from the tank 23 in the above description, but a cartridge system that integrates the tank and the droplet discharge head may also be used. In this case, the tank for storing the coating solution and the flow channel of the coating solution should be made of nonionic electroconductive material.

The manufacture of the liquid crystal display device of the present embodiment involves the formation of a thermosetting seal 2 by a dispenser or the like, for example, on the first substrate 1 on which the liquid crystal display element 106 is formed. The seal portion 2 is designed to include gap retention particles to maintain uniformly the gap between the substrates.

The inner side of the seal portion 2 is then coated with the liquid crystal using the above-described thin film fabrication apparatus 10, as is shown in FIG. 1. The gap retention particles are included in the liquid crystal to maintain uniformly the gap between the substrates.

The second substrate 4 on which the opposite second liquid crystal display element 107 is formed is then affixed while its positioning is being adjusted, and is affixed by pressurization in a vacuum; the resulting assembly is then heated for 10 minutes in a heating furnace at 120° C.; and the substrates are bonded to obtain an electrooptic device.

The coating solution 11 was described as a liquid crystal in the present embodiment, but it is not limited to liquid crystal in the present invention, and it is possible to coat the oriented films 105 with the coating solution using the droplet discharge head 12.

Next, the structure and method of manufacture will be described for an organic EL device, plasma display (PDP device), electron emission device (FED device or SED device), active matrix substrate formed on these display devices, and other devices manufactured using the thin film fabrication apparatus 10 relating to the present invention. The term “active matrix substrate” refers to a substrate on which are formed a thin film transistor and a source line and data line electrically connected to the thin film transistor.

This approach is also applicable to an organic EL device when, for example, a hole material, luminous material, or other such ink material for organic EL is used.

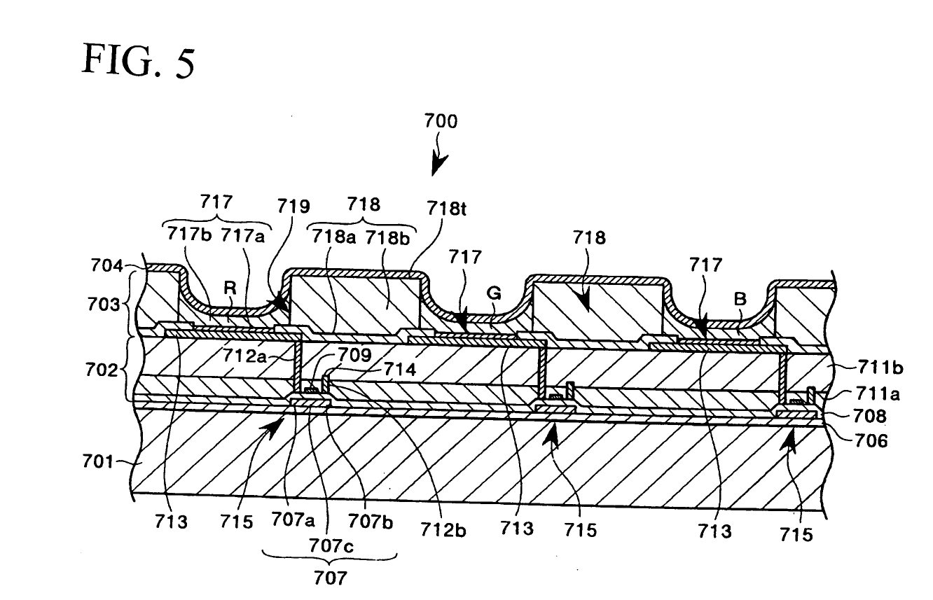

Next, FIG. 5 is a partial cross-sectional view of the display area (hereinafter referred to simply as the display device 700) of the organic EL device (also referred to as organic electroluminescence or OLED (organic light emitting diode)).

The display device 700 is essentially configured by stacking a circuit element 702, a light-emitting element 703, and a negative electrode 704 on a substrate (W) 701.

In the display device 700, light emitted from the light-emitting element 703 onto one side of the substrate 701 passes through the circuit element 702 and the substrate 701 to be emitted to an observer, while the light emitted from the light-emitting element 703 onto the other side of the substrate 701 is reflected by the negative electrode 704, and then passes through the circuit element 702 and the substrate 701 to be emitted to the observer.

A base protection film 706 having a silicon oxide film is formed between the circuit element 702 and the substrate 701, and an island shaped semiconductor film 707 composed of polycrystalline silicon is formed on the base protection film 706 (on the side facing the light-emitting element 703). A source area 707a and a drain area 707b are formed respectively in the left and right areas of the semiconductor film 707 by high-concentration cation implantation. The center section, which is not implanted with cations, constitutes a channel area 707c.

A transparent gate insulation film 708 covering the base protection film 706 and semiconductor film 707 is formed on the circuit element 702, and a gate electrode 709 configured from Al, Mo, Ta, Ti, W, or the like, for example, is formed at a location on the gate insulation film 708 corresponding to the channel area 707c of the semiconductor film 707. A transparent first layer insulation film 711a and a second layer insulation film 711b are formed on the gate electrode 709 and the gate insulation film 708. Also, contact holes 712a and 712b in communication with the source area 707a and drain area 707b, respectively, of the semiconductor film 707 are formed all the way through the first and second layer insulation films 711a and 711b.

Transparent pixel electrodes 713 composed of ITO or the like are then formed on the second layer insulation film 711b by being patterned into a specific shape, and these pixel electrodes 713 are connected to the source area 707a via the contact hole 712a.

Also, a power wire 714 is disposed on the first layer insulation film 711a, and this power wire 714 is connected to the drain area 707b via the contact hole 712b.

Thus, thin film transistors 715 for driving that are connected to the pixel electrodes 713 are formed on the circuit element 702.

The light-emitting element 703 is essentially configured from a plurality of function layers 717 stacked on each of the pixel electrodes 713, and bank parts 718 provided between each of the pixel electrodes 713 and the function layers 717 to partition off the function layers 717.

The light-emitting element is configured from the pixel electrodes 713, the function layers 717, and the negative electrode 704 disposed on the function layers 717. The pixel electrodes 713 are formed by being patterned into a rough rectangular shape as viewed in a plane, and the bank parts 718 are formed between the pixel electrodes 713.

The bank parts 718 have inorganic bank layers 718a (first bank layers) formed from SiO, SiO₂, TiO₂, or another such inorganic material, for example; and also comprise organic bank layers 718b (second bank layers) that are trapezoid in cross section, are stacked on the inorganic bank layers 718a, and are formed from a polyimide resin or another such resist with excellent heat resistance and solvent resistance. A portion of the bank parts 718 is formed to be resting on the edge of the pixel electrode 713.

Openings 719 that gradually expand above the pixel electrodes 713 are formed between the bank parts 718.

The function layers 717 have hole injection/transportation layers 717a formed in a stacked state in the openings 719 on the pixel electrodes 713, and luminescent layers 717b formed on the hole injection/transportation layers 717a. Other function layers having other functions may also be formed adjacent to the luminescent layers 717b. For example, electron transportation layers can also be formed.

The hole injection/transportation layers 717a have a function to transport the holes from the side facing the pixel electrodes 713 and to inject into the luminescent layers 717b. The hole injection/transportation layers 717a are formed by discharging a first composition (coating solution) containing a material that forms a hole injection/transportation layer. Conventional material is used as the material to form a hole injection/transportation layer.

The luminescent layers 717b are caused to emit red (R), green (G), or blue (B) light, and are formed by discharging a second composition (coating solution) containing a material to form a luminescent layer (luminescent material). Conventional material that is insoluble in the hole injection/transportation layers 717a is preferably used as the solvent (nonpolar solvent) for the second composition, and the use of such a nonpolar solvent in the second composition of the luminescent layers 717b makes it possible to form the luminescent layers 717b without re-dissolving the hole injection/transportation layers 717a.

The luminescent layers 717b are then configured such that light is emitted by the recombination of the holes injected from the hole injection/transportation layers 717a and the electrons injected from the negative electrode 704 in the luminescent layers.

The negative electrode 704 is formed to cover the entire surface of the light-emitting element 703, and is paired with the pixel electrodes 713 to fill the role of supplying an electric current to the function layers 717. A sealing member (not shown) is disposed at the top of the negative electrode 704.

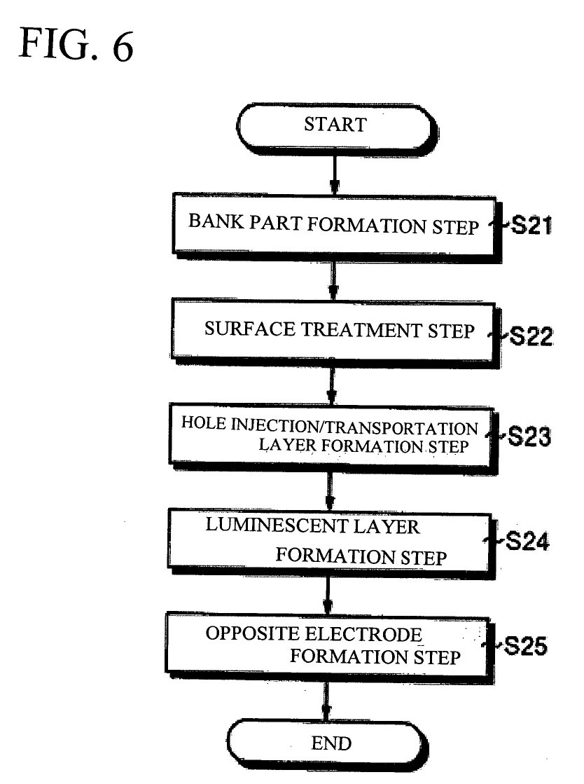

The process of manufacturing the above-mentioned display device 700 will now be described with reference to FIGS. 6 through 14.

The display device 700 is manufactured via a bank part formation step (S21), a surface treatment step (S22), a hole injection/transportation layer formation step (S23), a luminescent layer formation step (S24), and an opposite electrode formation step (S25), as shown in FIG. 6. The manufacturing process is not limited to the given example, and steps may be excluded or added as necessary.

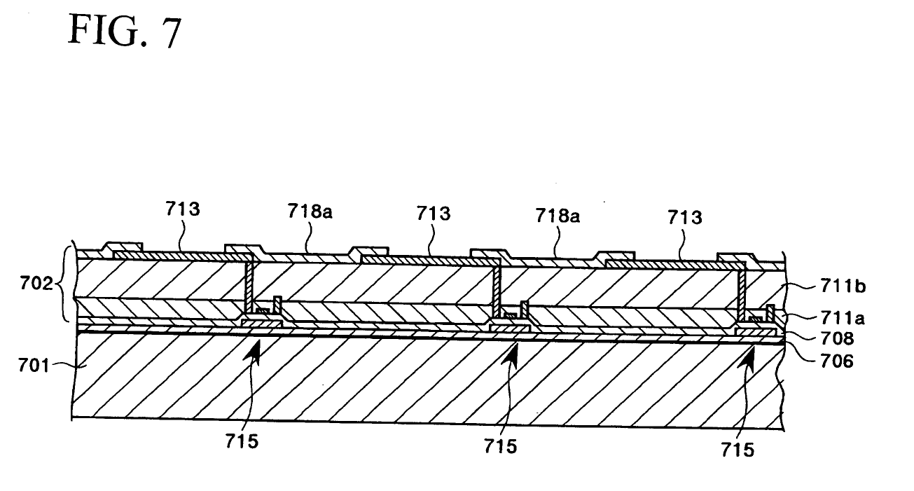

First, in the bank part formation step (S21), inorganic bank layers 718a are formed on the second layer insulation film 711b, as shown in FIG. 7. These inorganic bank layers 718a are formed by forming an inorganic film at a formation location and then patterning the inorganic film by photolithography or the like. At this point, a part of the inorganic bank layer 718a is formed to overlap the edge of the pixel electrode 713.

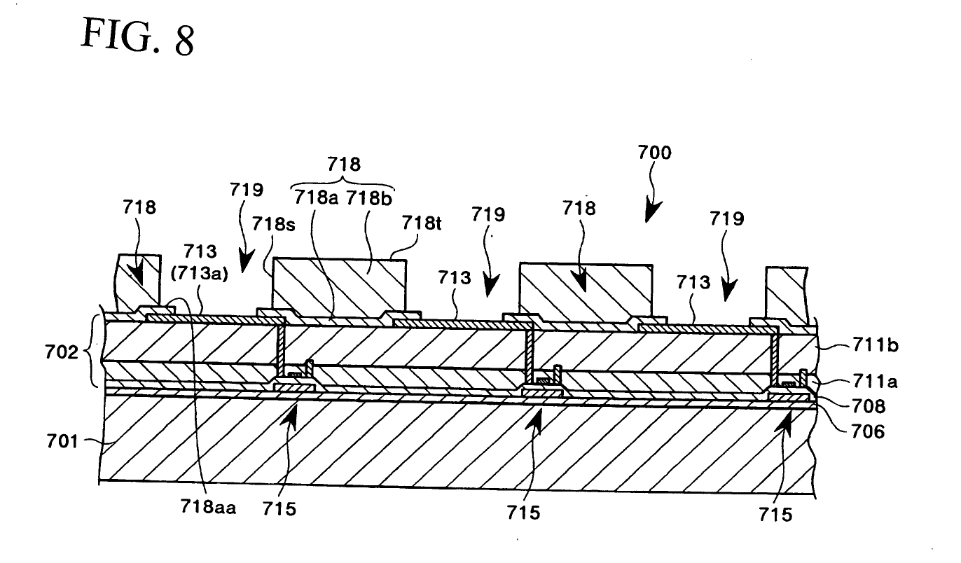

When the inorganic bank layers 718a are formed, the organic bank layers 718b are formed on the inorganic bank layers 718a as shown in FIG. 8. These organic bank layers 718b are also patterned by photolithography techniques or the like in the same manner as the inorganic bank layers 718a.

The bank parts 718 are formed in this manner. The openings 719 that open upward in relation to the pixel electrodes 713 are also formed accordingly between the bank parts 718. These openings 719 define the pixel area.

In the surface treatment step (S22), lyophilic treatment and liquid repellant treatment are performed. The areas subjected to lyophilic treatment are the first layered parts 718a of the inorganic bank layers 718a and the electrode surfaces 713a of the pixel electrodes 713, and these areas are subjected to a lyophilic surface treatment by a plasma treatment in which oxygen, for example, is used as a treatment gas. This plasma treatment also acts to wash the ITO that constitutes the pixel electrodes 713.

Also, the liquid repellant treatment is performed on the wall surfaces 718s of the organic bank layers 718b and the upper surfaces 718t of the organic bank layers 718b, and the surfaces are subjected to fluoride treatment (liquid repellant treatment) by a plasma treatment in which methane tetrafluoride, for example, is used as a treatment gas.

Performing this surface treatment step makes it possible for the coating solution droplets to land more reliably on the pixel area when the function layers 717 are formed using the droplet discharge head 12, and also makes it possible to prevent the coating solution droplets that have landed on the pixel area from overflowing in the openings 719.

A display device substrate 700A is thus obtained as a result of the steps described above. This display device substrate 700A is mounted on the substrate stage 16 of the thin film fabrication apparatus 1 shown in FIG. 1, and the following hole injection/transportation layer formation step (S23) and luminescent layer formation step (S24) are performed.

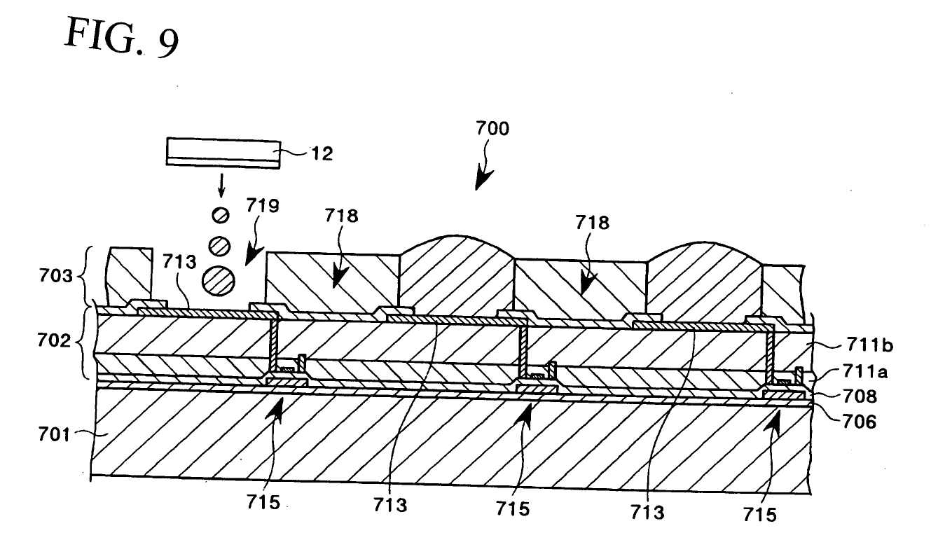

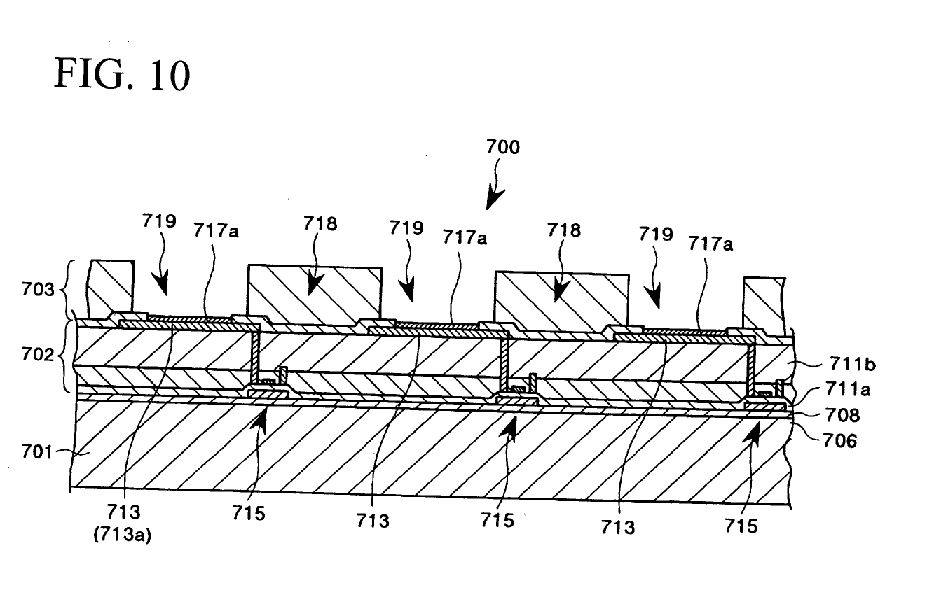

In the hole injection/transportation layer formation step (S23), the first composition that contains the hole injection/transportation layer formation material is discharged from the droplet discharge head 12 into the openings 719, which constitute the pixel area, as shown in FIG. 9. Then, drying treatment and heating treatment are performed, the polar solvent contained in the first composition is evaporated, and hole injection/transportation layers 717a are formed on the pixel electrodes (electrode surfaces 713a) 713, as shown in FIG. 10.

The luminescent layer formation step (S24) will now be described. In the luminescent layer formation step, a nonpolar solvent that does not dissolve the hole injection/transportation layers 717a is used as the solvent for the second composition used in luminescent layer formation, in order to prevent the hole injection/transportation layers 717a from dissolving again as described above.

However, since the hole injection/transportation layers 717a have a low affinity for nonpolar solvents, it is possible that the hole injection/transportation layers 717a and the luminescent layers 717b cannot be made to adhere to each other, or that the luminescent layers 717b cannot be uniformly coated, even if the second composition that contains the nonpolar solvent is discharged onto the hole injection/transportation layers 717a.

In view of this, a surface treatment (surface reforming treatment) is preferably performed prior to the luminescent layer formation in order to increase the affinity of the surface of the hole injection/transportation layers 717a for the nonpolar solvent and the luminescent layer formation material. The surface treatment is performed by coating the hole injection/transportation layers 717a with a surface reforming material, which is a solvent identical or similar to the nonpolar solvent of the second composition used in luminescent layer formation, and drying the resulting coating.

Applying such a treatment allows the surfaces of the hole injection/transportation layers 717a to dissolve easily in the nonpolar solvent and makes it possible the uniformly coat the hole injection/transportation layers 717a with the second composition that contains the luminescent layer formation material in the subsequent steps.

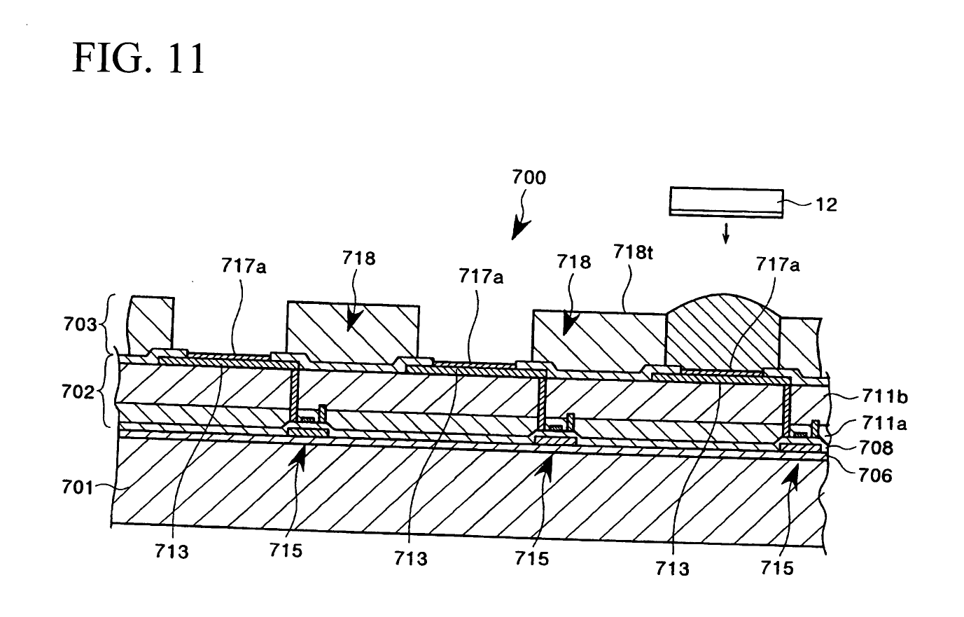

Next, the second composition with the luminescent layer formation material that corresponds to any of a variety of colors (blue (B) in the example in FIG. 11) is applied in a specific amount in the form of coating solution droplets onto the pixel area (openings 719), as shown in FIG. 11. The second composition applied into the pixel area expands onto the hole injection/transportation layers 717a and fills in the openings 719. If the second composition happens to miss the pixel area and strike the upper surface 718t of the bank parts 718, the second composition will easily flow into the openings 719 because the upper surface 718t has been subjected to a liquid repellent treatment as described above.

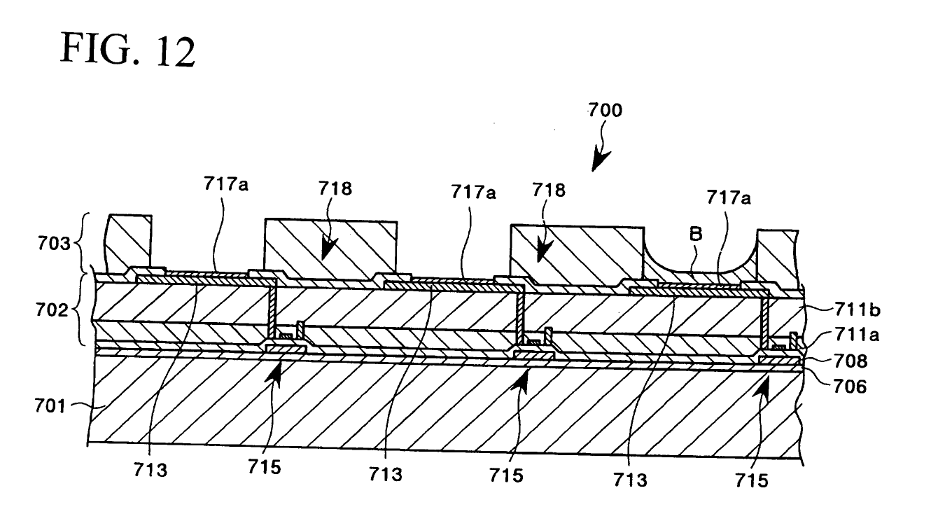

The discharged second composition is then subjected to a drying treatment by performing a drying step or the like, the nonpolar solvent contained in the second composition is evaporated, and the luminescent layers 717b are formed on the hole injection/transportation layers 717a as shown in FIG. 12. In this case, luminescent layers 717b corresponding to the color blue (B) are formed.

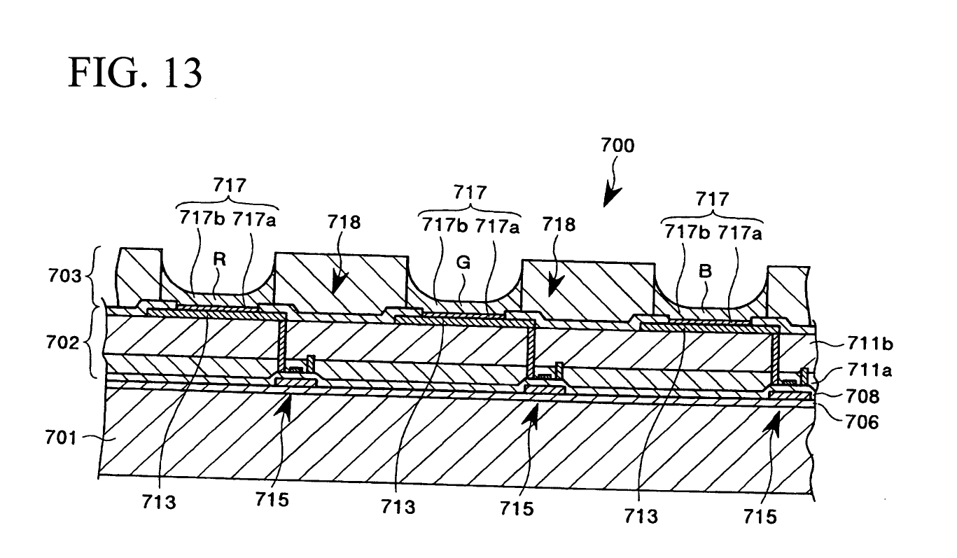

Similarly, the droplet discharge head 12 is used to perform sequentially the same steps as in the case of luminescent layers 717b that correspond to the color blue (B) as described above, and luminescent layers 717b corresponding to other colors (red (R) and green (G)) are formed, as shown in FIG. 13. The sequence of forming the luminescent layers 717b is not limited to the sequence herein exemplified, and the layers may be formed in any order. For example, the order of formation can be determined according to the luminescent layer formation material. The alignment pattern of the three colors red, green, and blue can be stripes, a mosaic, a delta, or other such alignment.

The function layers 717, or, specifically, the hole injection/transportation layers 717a and luminescent layers 717b are formed on the pixel electrodes 713 as described above. Next, the opposite electrode formation step (S25) is performed.

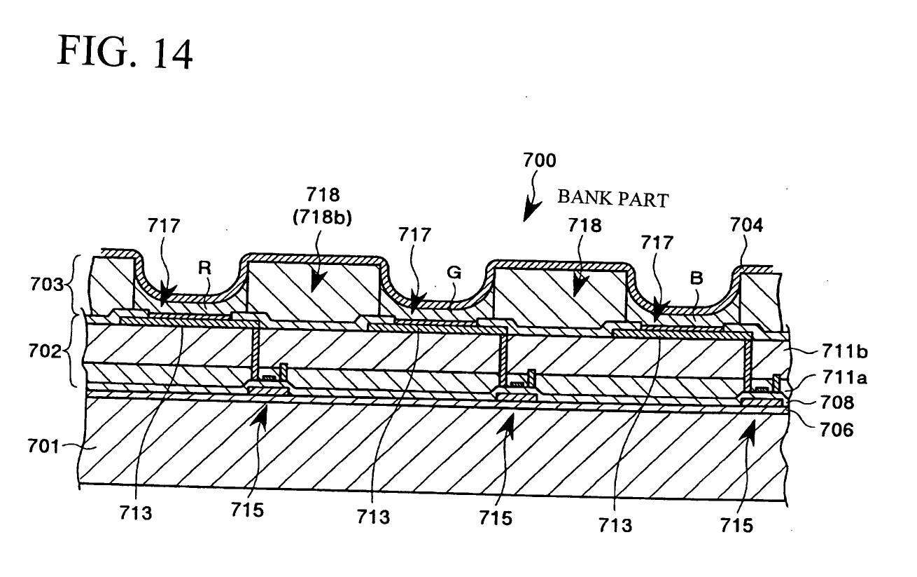

In the opposite electrode formation step (S25), a negative electrode 704 (opposite electrode) is formed on the entire surfaces of the luminescent layers 717b and the organic bank layers 718b by vapor deposition, sputtering, CVD, or the like, as shown in FIG. 14. In the present embodiment, the negative electrode 704 is configured by stacking a calcium layer and an aluminum layer, for example.

The top part of the negative electrode 704 is provided as necessary with an Al film and an Ag film as electrodes, and with a protective layer of SiO₂, SiN, or the like to prevent oxidation thereof.

After the negative electrode 704 is thus formed, a display device 700 is obtained by performing a wiring treatment, a sealing treatment wherein the top part of the negative electrode 704 is sealed with a seal member, or another such treatment.

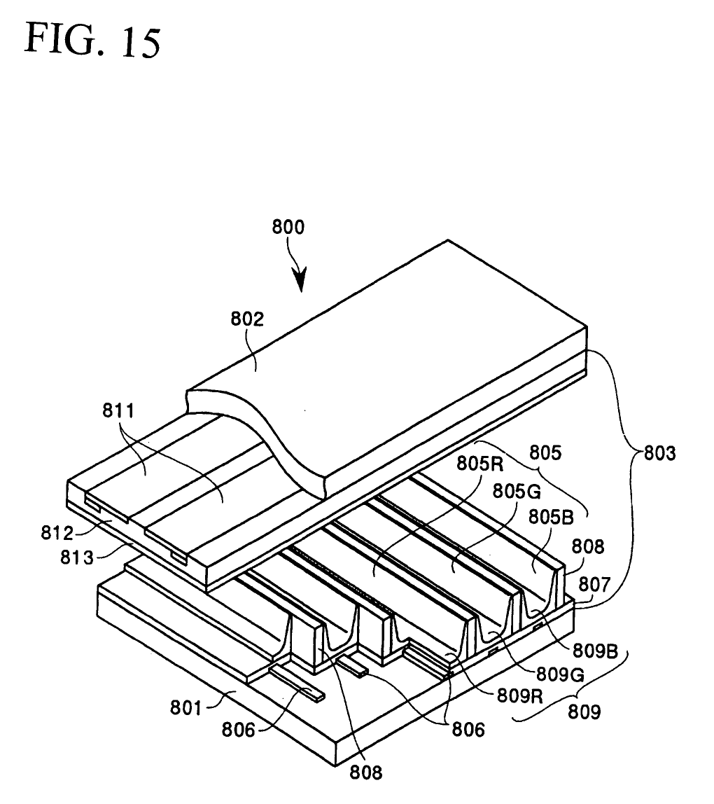

Next, FIG. 15 is a partial exploded perspective view of a plasma display device (PDP device; hereinafter referred to simply as the display device 800). This diagram shows the display device 800 partially cut away.

This display device 800 is essentially configured by including a first substrate 801 and a second substrate 802 disposed facing each other, and a discharge display part 803 formed between these two substrates. The discharge display part 803 is configured from a plurality of discharge chambers 805. Within this plurality of discharge chambers 805, three discharge chambers 805 made of a red discharge chamber 805R, a green discharge chamber 805G, and a blue discharge chamber 805B constitute a group and are aligned to form one picture element.

Address electrodes 806 are formed in a striped configuration at specific intervals on the upper surface of the first substrate 801, and a dielectric layer 807 is formed to cover the address electrodes 806 and the upper surface of the first substrate 801. Partitioning walls 808 located between the address electrodes 806 are formed on the dielectric layer 807 to extend along the address electrodes 806. The partitioning walls 808 include those that are shown in the diagram and extend on both sides in the width direction of the address electrodes 806, and those that are not shown in the diagram and extend in the direction perpendicular to the address electrodes 806.

The areas partitioned off by the partitioning walls 808 form the discharge chambers 805.

A fluorescent substance 809 is disposed in the discharge chambers 805. The fluorescent substance 809 emits fluorescent light in colors of red (R), green (G), and blue (B), so a red fluorescent substance 809R is disposed in the lower section of the red discharge chamber 805R, a green fluorescent substance 809G is disposed in the lower section of the green discharge chamber 805G, and a blue fluorescent substance 809B is disposed in the lower section of the blue discharge chamber 805B.

A plurality of display electrodes 811 is formed in a striped configuration at specific intervals in the direction perpendicular to the above-mentioned address electrodes 806 on the surface of the second substrate 802 at the bottom of the diagram. A dielectric layer 812 and a protective layer 813 composed of MgO or the like are formed to cover these electrodes.

The first substrate 801 and the second substrate 802 are affixed so that the address electrodes 806 and the display electrodes 811 face each other in a mutually orthogonal arrangement. The above-mentioned address electrodes 806 and the display electrodes 811 are connected to an AC power source (not shown).

The fluorescent substance 809 is excited and caused to emit light in the discharge display part 803 by the energizing of the electrodes 806 and 811, and images can be displayed in color.

In the present embodiment, the above-mentioned address electrodes 806, display electrodes 811, and fluorescent substance 809 can be formed using the thin film fabrication apparatus 1 shown in FIG. 1. The step for molding the address electrodes 806 in the first substrate 801 is exemplified below.

In this case, the following step is performed in a state in which the first substrate 801 is mounted on the substrate stage 12 of the thin film fabrication apparatus 1.

First, a liquid material (coating solution) containing the material for forming conductive film wiring is sprayed as coating solution droplets on the address electrode formation area by the droplet discharge head 12. This liquid material is made of metallic or other such conductive fine particles dispersed in a dispersion medium as material to form conductive film wiring. Metallic fine particles or a conductive polymer containing gold, silver, copper, palladium, nickel, or the like is used as the conductive fine particles.

When the filling of all the address electrode formation areas with liquid material is complete, the discharged liquid material is subjected to drying treatment, and the dispersion medium contained in the liquid material is evaporated to form the address electrodes 806.

The formation of the address electrodes 806 was exemplified above, but the above-mentioned display electrodes 811 and fluorescent substance 809 can also be formed by the steps described above.

When the display electrodes 811 are formed, the liquid material (coating solution) containing the material to form the conductive film wiring is sprayed over the display electrode formation areas as coating solution droplets, similar to the case of the address electrodes 806.

Also, when the fluorescent substance 809 is formed, a liquid material (coating solution) that contains fluorescent material corresponding to each color (R, G, B) is discharged as droplets from the droplet discharge head 12 and is sprayed into the discharge chambers 805 of the corresponding colors.

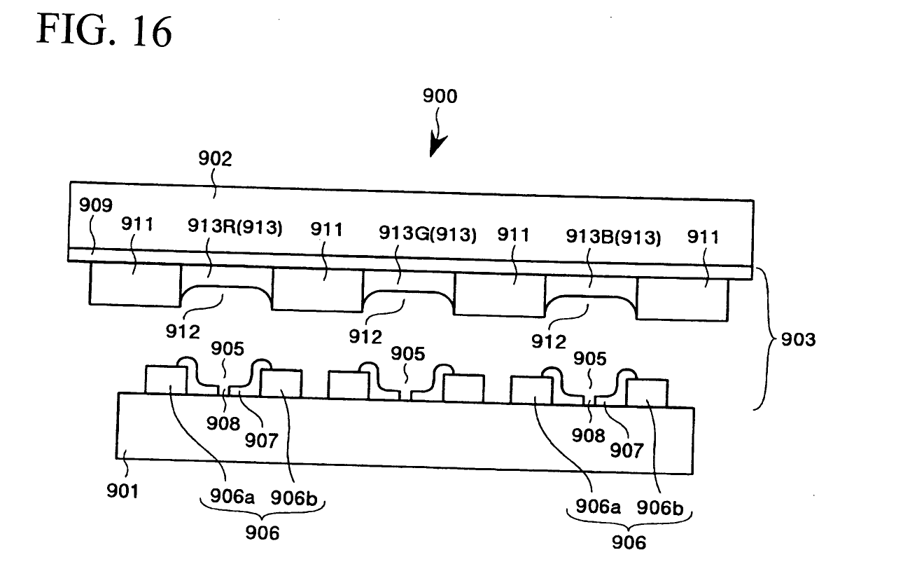

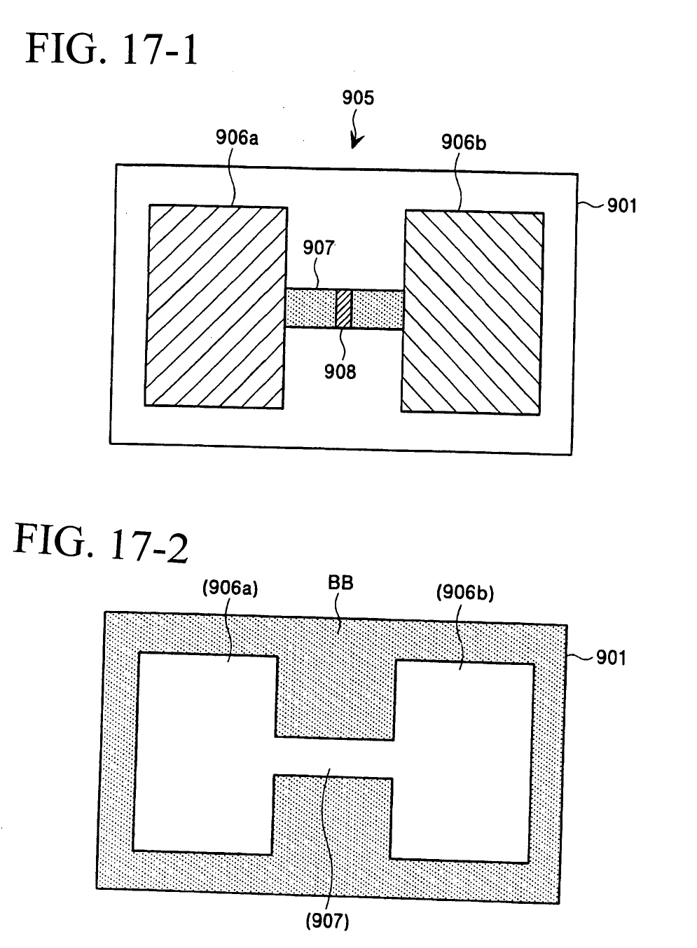

FIG. 16 is a partial cross-sectional view of an electron emission device (FED (field emission display) device or SED (surface condition electron emitter display) device; hereinafter also referred to simply as the display device 900). This diagram shows the display device 900 partially cut away.

This display device 900 is essentially configured with a first substrate 901 and a second substrate 902 disposed facing each other, and a field emission display part 903 formed between these two substrates. The field emission display part 903 is configured from a plurality of electron emission parts 905 disposed in a matrix configuration.

A first element electrode 906a and a second element electrode 906b, which constitute a cathode electrode 906, are formed to be mutually orthogonal on the upper surface of the first substrate 901. A conductive film 907 with a gap 908 is formed in the area partitioned off by the first element electrode 906a and second element electrode 906b. Specifically, a plurality of electron emission parts 905 is configured from the first element electrode 906a, the second element electrode 906b, and the conductive film 907. The conductive film 907 is composed, for example, of palladium oxide (PdO) or the like, and the gap 908 is formed by foaming or the like after the conductive film 907 is molded.

The material constituting the conductive film 907 is not limited to PdO, and other possible examples include Pd, Pt, Ru, Ag, Au, Ti, In, Cu, Cr, Fe, Zn, Sn, Ta, W, Pb, and other such metals; SnO₂, In₂O₃, PbO, Sb₂O₃, and other such oxides; HfB₂, ZrB₂, LaB₆, CeB₆, YB₄, GdB₄, and other such borides; TiC, ZrC, HfC, TaC, SiC, WC, and other such carbides; TiN, ZrN, HfN, and other such nitrides; and Si, Ge, and other such semiconductors, as well as carbon and the like.

Also, the conductive film 907 is preferably a microparticulate film configured from fine particles to obtain satisfactory electron emission properties, and the film thickness thereof is set as necessary according to the step coverage in the element electrodes, the resistance value between the element electrodes, the conductive foaming conditions, and the like, but the film thickness is preferably several angstroms to several thousand angstroms, or more preferably 10 Å to 500 Å. The sheet resistance value thereof is preferably 10³ to 10⁷ Ω/□. The microparticulate film discussed herein is a film obtained by aggregating a plurality of fine particles, and this term refers not only to a film made of individually dispersed fine particles, but also to a film made of fine particles that are adjacent to or overlap each other (including island shapes) as the fine structure thereof, wherein the grain size of the fine particles should be several angstroms to several thousand angstroms, and preferably 10 Å to 200 Å.

An anode electrode 909 facing the cathode electrode 906 is formed on the lower surface of the second substrate 902. A lattice-shaped bank part 911 is formed on the lower surface of the anode electrode 909, and a fluorescent substance 913 that corresponds to the electron emission parts 905 is disposed in downward-facing openings 912 enclosed by the bank part 911. The fluorescent substance 913 emits fluorescent light of the colors red (R), green (G), and blue (B), and a red fluorescent substance 913R, a green fluorescent substance 913G, and a blue fluorescent substance 913B are disposed in the openings 912 in the specific pattern described above.

The first substrate 901 and the second substrate 902 configured in this manner are affixed to allow a small gap to remain. In the display device 900, electrons emitted from the first element electrode 906a or the second element electrode 906b, which are negative electrodes, pass through the conductive film (gap 908) 907 to strike the fluorescent substance 913 formed on the anode electrode 909, which is a positive electrode, such that the substance is excited and caused to emit light to allow colored images to be displayed.

In this case, as in the other embodiments, the first element electrode 906a, second element electrode 906b, conductive film 907, and anode electrode 909 can be formed using the thin film fabrication apparatus 1, and also the fluorescent substances 913R, 913G, and 913B of each color can be formed using the thin film fabrication apparatus 1.

The first element electrode 906a, second element electrode 906b, and conductive film 907 have the planar shape shown in FIG. 17-1, and when a film is formed thereon, the sections provided in advance with the first element electrode 906a, second element electrode 906b, and conductive film 907 are allowed to remain, and a bank part BB is formed (photolithography) as shown in FIG. 17-2. Next, the first element electrode 906a and the second element electrode 906b are formed (by ink jetting with the thin film fabrication apparatus 1) in the groove section formed by the bank part BB, the solvent is dried to form the film, and the conductive film 907 is then formed (ink jetting with the thin film fabrication apparatus 1). After the conductive film 907 is formed, the bank part BB is removed (ashing removal treatment), and the process proceeds to the above-mentioned foaming treatment. It is then preferable to perform lyophilic treatment on the first substrate 901 and the second substrate 902, and to perform liquid repellant treatment on the bank parts 911 and BB, similar to when the above-mentioned organic EL device is used.

Other possible examples of electrooptical devices include devices for metal wiring formation, lens formation, resist formation, light diffuser formation, and the like. It is possible to manufacture efficiently various electrooptical devices by using the thin film fabrication apparatus 1 described above in the manufacture of these various electrooptical devices.

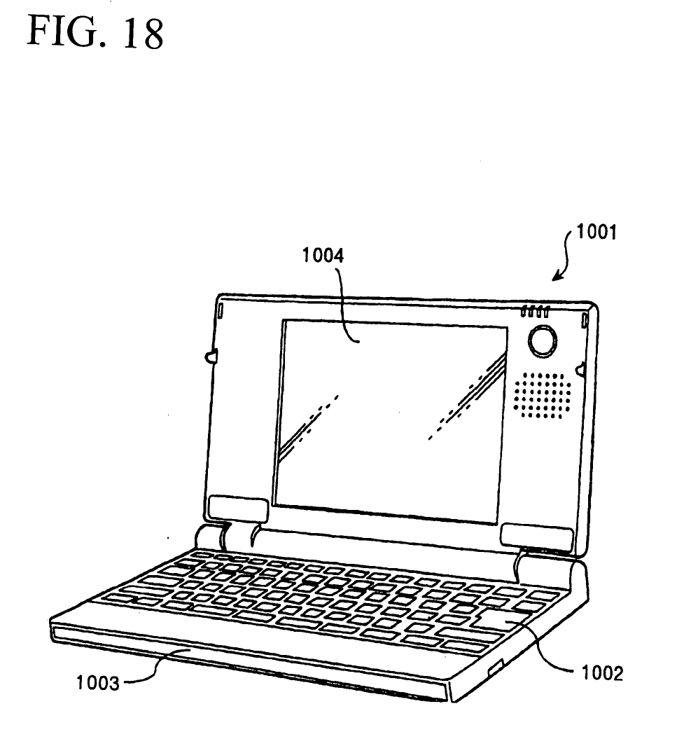

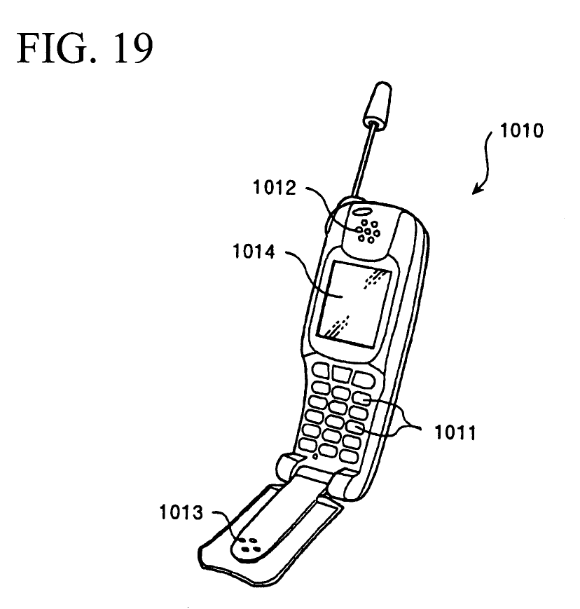

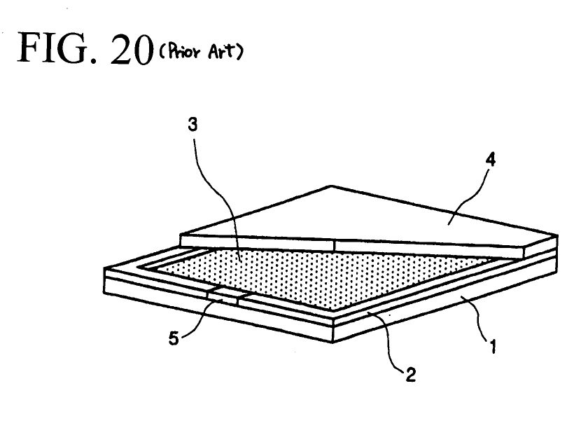

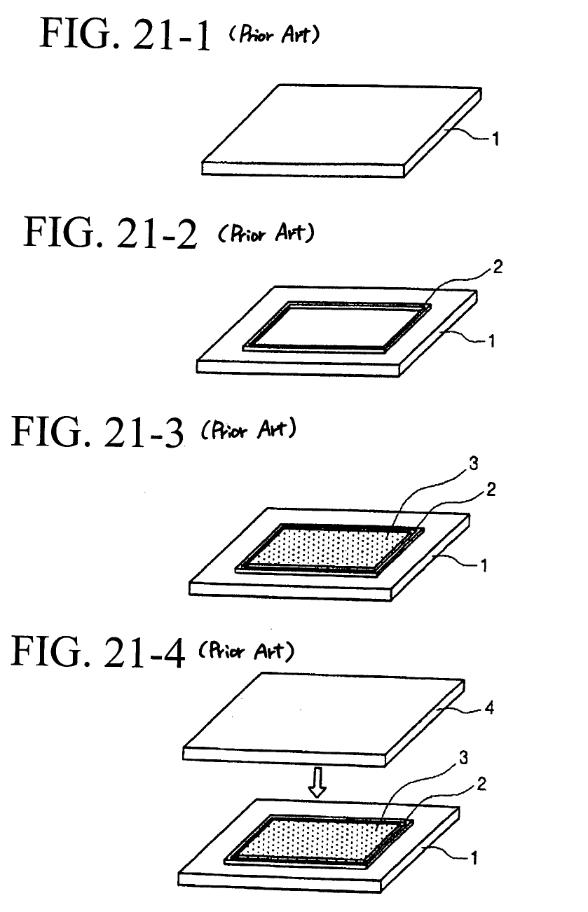

Next, a specific example of an electronic device to which the liquid crystal display panel relating to the present invention can be applied will be described with reference to FIGS. 18 and 19.

First, an example in which the liquid crystal display panel relating to the present invention is applied to the display part of a portable personal computer (so-called notebook PC) will be described. FIG. 18 is a perspective view showing the configuration of the personal computer. As shown in this diagram, the personal computer 1001 includes a main body 1003 with a keyboard 1002 and a display part 1004 to which the liquid crystal display panel relating to the present invention is applied.

An example in which the liquid crystal display panel relating to the present invention is applied to the display part of a portable phone will now be described. FIG. 19 is a perspective view showing the configuration of the portable phone.

As shown in this diagram, the portable phone 1010 includes a plurality of operating buttons 1011, as well as an earpiece 1012, a mouthpiece 1013, and a display part 1014 to which the liquid crystal display panel relating to the present invention is applied.

Examples of the electronic device to which the liquid crystal display panel relating to the present invention can be applied include the personal computer shown in FIG. 18 and the portable phone shown in FIG. 19, as well as, for example, liquid crystal TVs, viewfinder or direct-view video tape recorders, car navigation systems, pagers, electronic notebooks, calculators, word processors, workstations, picture phones, POS terminals, digital still cameras, and the like, but the device is not limited to these examples.

In the embodiments described above, the application of the liquid crystal device to an electrooptical device was also described, but the present invention is not limited thereto and can also be applied to electroluminescence devices, particularly organic electroluminescence devices, inorganic electroluminescence devices, plasma display devices, FED (field emission display) devices, LED (light-emitting diode) display devices, electric electrophoretic display devices, compact TVs that use liquid crystal shutters or the like, devices that use digital micromirror displays (DMD), and other such various electrooptical devices.

As described above, the thin film fabrication apparatus relating to the present embodiment can be applied to the manufacture of a color filter using the liquid crystal or other component of an electrooptic device, for example, wherein charging in the coating solution is prevented, contamination of the coating solution with dirt, dust, and other such foreign matter, for example, is inhibited, disruption of the molecular orientation is resolved, and droplets can be discharged in a stable manner due to the use of an antistatic material for at least a part of the area in contact with the coating solution.

The terms “front,” “back, “up,” “down,” “perpendicular,” “horizontal,” “slanted,” and other direction-related terms used above indicate the directions in the diagrams used herein. Therefore, the direction-related terms used to describe the present invention should be interpreted in relative terms as applied to the diagrams used.

Substantially,” “essentially,” “about,” and other approximation-indicating terms used above represent a reasonable amount of deviation that does not bring about a considerable change as a result. Terms that represent these approximations should be interpreted so as to include an error of about ±5% at least, as long as there is no considerable change due to the deviation.

The entire disclosures in Japanese Patent Application Nos. 2003-065318 and 2004-040066 are incorporated in this specification by reference.

The embodiments described above constitute one part of the embodiments of the present invention, and it is apparent to those skilled in the art that it is possible to add modifications to the above-described embodiments by using the above-described disclosure without exceeding the range of the present invention as defined in the claims. The above-described embodiments furthermore do not limit the range of the present invention, which is defined by the accompanying claims or equivalents thereof, and are only designed to provide a description of the present invention.

1. A thin film fabrication apparatus for forming a thin film on a substrate, comprising:
a substrate stage to hold the substrate; and
a droplet discharge head being disposed above said substrate stage and designed to discharge a coating solution onto the substrate, at least a part of an area in contact with said coating solution is configured from antistatic material.

2. The thin film fabrication apparatus according to claim 1, wherein said antistatic material is nonionic material.

3. The thin film fabrication apparatus according to claim 2, wherein said antistatic material is nonionic electroconductive material.

4. The thin film fabrication apparatus according to claim 1, wherein said antistatic material comprises a nonionic surfactant kneaded into nonionic material.

5. The thin film fabrication apparatus according to claim 4, wherein said a nonionic material is a resin material selected from the group consisting of polypropylene, polyethylene, and polystyrene.

6. The thin film fabrication apparatus according to claim 1, wherein said antistatic material is obtained by coating nonionic material with a nonionic surfactant.

7. The thin film fabrication apparatus according to claim 6, wherein said nonionic material is a resin material selected from the group consisting of polypropylene, polyethylene, and polystyrene.

8. The thin film fabrication apparatus according to claim 1, wherein said coating solution is liquid crystal.

9. The thin film fabrication apparatus according to claim 1, further comprising,
a controller electrically connected to said substrate stage and said discharge head to control the relative positions of said substrate stage and said discharge head and to control discharge of said coating solution from said discharge head.

10. The thin film fabrication apparatus according to claim 9, wherein said droplet discharge head is a piezojet type.

11. A thin film fabrication apparatus for forming a thin film on a substrate, comprising:
a substrate stage to hold the substrate;
a droplet discharge head being disposed above said substrate stage and designed to discharge a coating solution onto the substrate;
a tank to contain said coating solution; and
an antistatic tube to connect said tank and said droplet discharge head to supply said coating solution from said tank to said droplet discharge head.

12. The thin film fabrication apparatus according to claim 11, wherein said tube is configured from antistatic material.

13. The thin film fabrication apparatus according to claim 12, wherein said antistatic material is nonionic material.

14. The thin film fabrication apparatus according to claim 13, wherein said antistatic material is nonionic electroconductive material.

15. The thin film fabrication apparatus according to claim 12, wherein said antistatic material comprises a nonionic surfactant kneaded into nonionic material.

16. The thin film fabrication apparatus according to claim 15, wherein said nonionic material is a resin material selected from the group consisting of polypropylene, polyethylene, and polystyrene.

17. The thin film fabrication apparatus according to claim 12, wherein said tube is obtained by coating nonionic material with a nonionic surfactant.

18. The thin film fabrication apparatus according to claim 17, wherein said nonionic material is a resin material selected from the group consisting of polypropylene, polyethylene, and polystyrene.

19. The thin film fabrication apparatus according to claim 11, wherein said coating solution is liquid crystal.

20. The thin film fabrication apparatus according to claim 11, wherein said tank is configured from antistatic material.

21. The thin film fabrication apparatus according to claim 20, wherein at least a part of a portion of said droplet discharge head in contact with said coating solution is configured from antistatic material.

22. The thin film fabrication apparatus according to claim 21, further comprising, a controller electrically connected to said substrate stage and said discharge head to control relative positions of said substrate stage and said discharge head and to control discharge of said coating solution from said discharge head.

23. The thin film fabrication apparatus according to claim 22, wherein said droplet discharge head is a piezojet type.
